(19) United States
(12) Patent Application Publication
(10) Pub. No.: US 2025/0067505 A1
(43) Pub. Date: Feb. 27, 2025

(54) BACK BUMPER FOR CAN RACK SYSTEMS

(71) Applicants: BSH Home Appliances Corporation, Irvine, CA (US); BSH Hausgeräte GmbH, Munich (DE)

(72) Inventors: Sarah Gluck Griswold, Powell, TN (US); Narendra Mal, Knoxville, TN (US)

(21) Appl. No.: 18/236,421

(22) Filed: Aug. 22, 2023

(51) Int. Cl. F25D 31/00; A47F 1/08; A47F 7/28; B65G 11/20

(52) U.S. Cl. CPC F25D 31/007; A47F 1/08; A47F 7/281; B65G 11/203

(57) ABSTRACT

A back bumper can be provided for slowing cans inserted into a can rack system. The back bumper can include a first flap, which can flex downward in response to pressure exerted by a can descending through a compartment of the can rack system. The first flap can further flex upward when the can descending through the compartment is below and no longer in contact with the first flap. The back bumper can also include a second flap, which may be positioned perpendicular to the first position of the first flap. The back bumper can further include a raised step positioned between the second flap and the first flap. The raised step can allow the first flap to move independently of the second flap. Additionally, a flange can protrude from the second flap. The flange and the second flap can removably couple the back bumper to the can rack system.

### TECHNICAL FIELD

The present disclosure relates generally to refrigeration systems and, more particularly (although not necessarily exclusively), to slowing cans inserted into can rack systems of refrigeration appliances via back bumpers.

### BACKGROUND

Household appliances such as refrigerators can include shelves and drawers for storing items. The house appliances can also include item-specific compartments such as can racks. The can racks can be used to store canned drinks, canned foods, or the like to improve organization within the household appliance and to improve accessibility with respect to canned items. The can racks may be positioned in the refrigeration appliance and may take up substantial space. Therefore, it may be desirable to design a can rack that can fit seamlessly around or near other features of a household appliance. Additionally, users may misuse can racks. For example, users may dispose of or position cans incorrectly within a can rack or may use the can rack to store non-canned items. Misuse of a can rack may cause damage to the non-canned items, cans, or to the can rack itself. Moreover, when cans are inserted into a can rack, the cans may gain speed while falling to a bottom of the can rack or on to another can. As a result, the cans may contact the bottom or another can with significant force, which can also cause damage to the cans or the can rack. Thus, it may be desirable slow cans falling through the can rack. In addition, if maintenance or other services involve disassembling a can rack, it may be advantageous for the can rack or features of the can rack, to be removable using minimal tools.

### BRIEF DESCRIPTION OF THE DRAWINGS

FIG. 1 depicts an example of a refrigeration appliance according to some embodiments of the present disclosure.

FIG. 2 depicts an example of a back bumper for a can rack system according to some embodiments of the present disclosure.

FIG. 3 depicts another example of a back bumper for a can rack system according to some embodiments of the present disclosure.

FIG. 4 depicts another example of a back bumper for a can rack system according to some embodiments of the present disclosure.

FIG. 5 depicts another example of a back bumper for a can rack system according to some embodiments of the present disclosure.

FIG. 6 depicts another example of a back bumper for a can rack system according to some embodiments of the present disclosure.

FIG. 7 depicts an example of a back bumper coupled with a can rack system according to some embodiments of the present disclosure.

FIG. 8 depicts a front view of a front loading can rack system with a set of back bumpers according to some embodiments of the present disclosure.

FIG. 9 depicts a back view of the front loading can rack system with the set of back bumpers according to some embodiments of the present disclosure.

FIG. 10 depicts a cross sectional view of the front loading can rack system with a set of back bumpers according to some embodiments of the present disclosure.

FIG. 11 is a flowchart of process for installing a back bumper in a front loading can rack system according to one example of the present disclosure.

### DETAILED DESCRIPTION

Certain aspects and examples of the present disclosure relate to a back bumper for slowing cans in a can rack system. More specifically, aspects and examples of the present disclosure are directed to a removable back bumper for a front loading can rack system with a top cover. The top cover of the front loading can rack system can prevent users from incorrectly inserting cans into the front loading can rack system.

The front loading can rack system can include a first front opening positioned directly below the top cover though which a user can insert cans into the front loading can rack system. The first front opening can be positioned and sized to promote correct insertion of cans in the front loading can rack system. For example, the first front opening can be rectangular with a width that is greater than a height to promote horizontal insertion of cans. In this way, cans cannot be inserted incorrectly (e.g., vertically) into the front loading can rack system and non-canned objects or objects that are too large for the front loading can rack system cannot be inserted into the front loading can rack system, thereby minimizing a risk of damage to the front loading can rack system. The front loading can rack system can also include a second front opening through which cans can be dispensed. For example, the first front opening can be on a top portion of the front loading can rack system and a second front opening can be on a bottom portion of the front loading can rack system. Thus, a can may be inserted into a compartment of the front loading can rack system via the first front opening. After insertion, the can may fall through the compartment to a bottom of the front loading can rack. A user may then retrieve the can from the front loading can rack system via the second front opening.

As the can falls through the compartment, the can may be slowed by one or more back bumpers. For example, a back wall of the front loading can rack system can include slots, and a back bumper can be at least partially inserted through each of the slots. In particular, a flange of each of the back bumpers can be inserted through each of the slots. In doing so, a first flap of each back bumper can be positioned within a body of the front loading can rack system (e.g., the compartment). The first flap can project a distance into the compartment sufficient for contacting the cans falling through the compartment. That is, the first flap can extend far enough to slow the cans. The first flap can have an initial position associated with the first flap not being in contact with a can. The first flap may then flex downward while a can falling through the compartment is in contact with, and is therefore exerting pressure and force on, the first flap. To slow the cans, while flexing downward, the first flap can provide some resistance to the pressure and force exerted by falling can. Once the can is below and no longer in contact with the first flap, the first flap can return to the initial position. Thus, the first flap can flex downward and rebound back, and can do so over many cycles of cans falling.

The back bumpers can also include a second flap, which may be perpendicular to the first flap. A raised step can be between the first flap and the second flap. Thus, the first flap can be separated from the second flap by the raised step as to allow the first flap to move independently of the second flap. Additionally, the flange can protrude from the second flap. The flange and second flap can couple the back bumper to a can rack system. For example, inserting the flange through a slot of the front loading can rack system can include hooking the flange and second flap on to the back wall. As a result, the second flap may be disposed on an inner side of the back wall and the flange may be disposed on an outer side of the back wall. The flange can further include a flange hole, and the back wall can include a protruding portion. The protruding portion can be coupled with the flange hole to secure the coupling of the second flap and flange to the back wall.

Moreover, because the back bumpers can be removably attached to can rack systems, such as the front loading can rack system, rather than being an additional feature of a main body of the can rack systems, the back bumpers can be a cost-effective solution for slowing cans. The removability of the back bumpers can also allow for different back bumper designs to be employed within the front loading can rack system or other suitable can rack systems. Thus, the back bumpers can be interchangeable depending on, for example, a size of the cans inserted into the can rack system. For example, back bumpers with a longer first flap can be used for food cans, which may be heavier than beverage cans. The removability of the back bumpers further enables easy cleaning and replacement.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

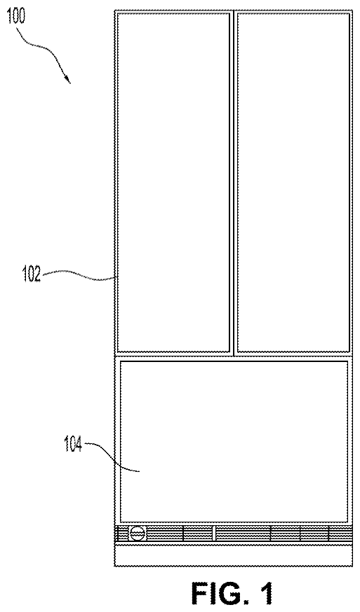

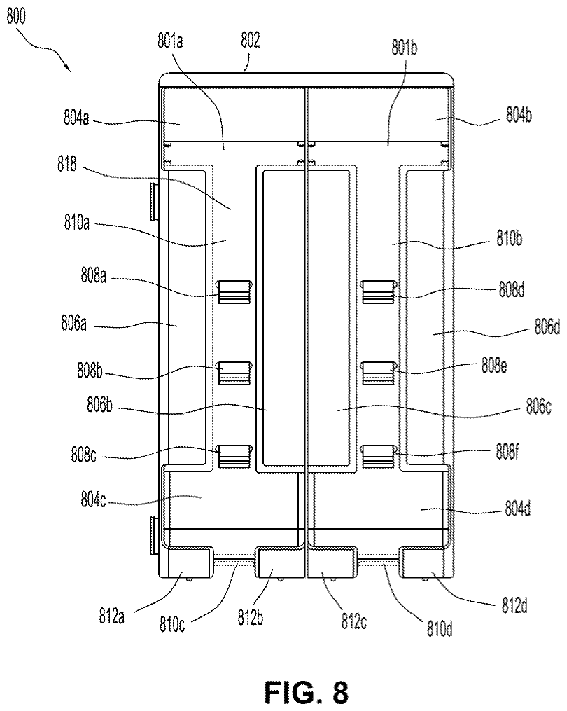

FIG. 1 depicts an example of a refrigeration appliance 100 according to some embodiments of the present disclosure. The refrigeration appliance 100 can be a refrigerator, a freezer, or a combination thereof. For example, the refrigeration appliance 100 can include a first cabinet 102 defining a refrigeration space and a second cabinet 104 defining a freezer space. The first cabinet 102 and the second cabinet 104 may be arranged in various orientations, such as the first cabinet 102 positioned above the second cabinet 104 as depicted in FIG. 1. In another example, the first cabinet 102 may be positioned side by side or below the second cabinet 104, or in any other suitable arrangement. The first cabinet 102 or the second cabinet 104 may include a can rack, such as the front loading can rack system 800 depicted in FIG. 8. The first cabinet 102 or the second cabinet 104 may further include an ice maker. For example, the ice maker can be positioned on an inner side of a door of the first cabinet 102 and the can rack can be coupled to the ice maker.

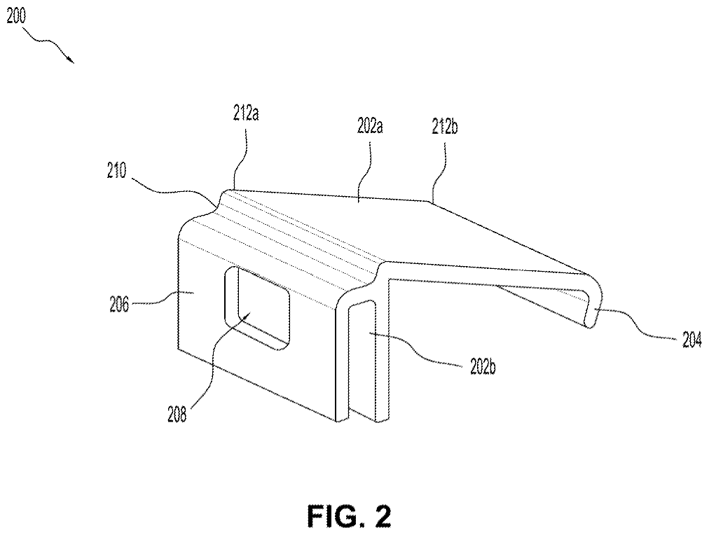

FIG. 2 depicts an example of a back bumper 200 for a can rack system according to some embodiments of the present disclosure. The back bumper 200 can include a first flap 202a. The first flap 202a can be a flat flap and can repeatedly flex as cans are inserted into the can rack system, such as the front loading can rack system 800 depicted in FIG. 8.

In an example, a can may be inserted into the can rack system. The can may then fall through a compartment of the can rack system to a bottom of the can rack system or on to another can stored in the can rack system. As depicted, before the can contacts the first flap 202a, the first flap 202a can be in a first position. Then, while the falling can is in contact with the first flap 202a, the first flap 202a can flex downward. The first flap 202a can provide some resistance to the motion of the falling can to slow the can. Once the can is below the first flap 202a, the first flap 202a can return to the first position. The first flap 202a can retain its size, shape, and impact resistance while repeatedly flexing downward and returning to the first position as cans are inserted and removed from the can rack system.

Additionally, a hooked portion 204 can extend from a second edge 212b of the first flap 202a. The hooked portion 204 can prevent items (e.g., cans) below the first flap 202a from directly pushing up on the first flap 202a. Thus, the hooked portion 204 can protect a structural integrity of the first flap 202a and can prevent cans from being pushed out of a top of the can rack system.

The back bumper 200 can also include a second flap 202b. A raised step 210 can extend from a first edge 212a of the first flap 202a and can be positioned between the first flap 202a and the second flap 202b. The raised step can enable the first flap 202a to move independently of the second flap 202b. In some examples, the first flap 202a and the second flap 202b can be made of the same material, such as a rubber material. Alternatively, the second flap 202b can be made of a different material than the first flap 202a. For example, the second flap 202b can be made of a first material that has a greater stiffness than a second material of the first flap 202a.

Additionally, a flange 206 can protrude from the second flap 202b for enabling the back bumper 200 to be removably coupled to the can rack system. The flange 206 can include a flange hole 208, which can be used to further secure the connection between the can rack system and the back bumper 200. The flange hole 208 can also provide visibility to facilitate installation of the back bumper 200 on to the can rack system. Additionally, after installation, the flange hole 208 can enable a user to see that the back bumper 200 has been installed correctly. In this way, the flange hole 208 can ensure intended use of the back bumper 200 and can reduce a risk of damaging the back bumper 200 or the can rack system during installation.

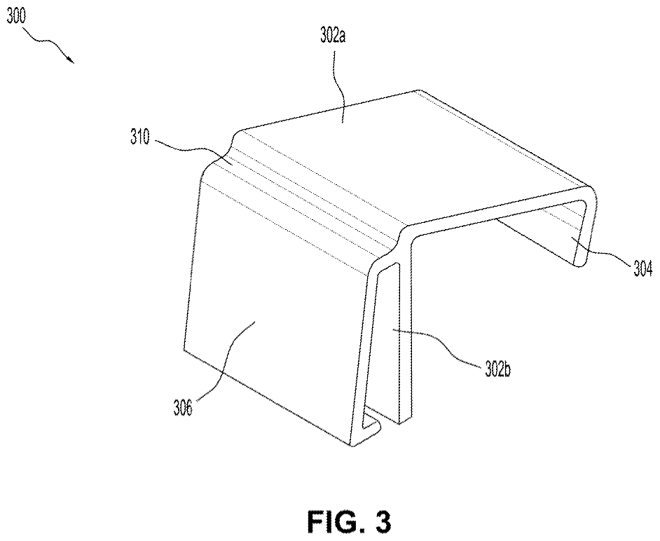

FIG. 3 depicts another example of a back bumper 300 for a can rack system according to some embodiments of the present disclosure. The back bumper 300 can include a first flap 302a, which can be a flexible flap for slowing cans inserted into the can rack system. The can rack system may correspond to the front loading can rack system 800 depicted in FIG. 8.

In an example, a can may be falling through a body or compartment of the can rack system. Before the can contacts the first flap 302a, the first flap 302a can be in a first position. Then, while the falling can is in contact with the first flap 302a, the first flap 302a can flex downward while providing some resistance to the motion of the can. As a result, a speed of the can may decrease. Once the can is below the first flap 302a, the first flap 302a can return to the first position. The first flap 302a can retain its size, shape, and impact resistance while repeatedly flexing downward and returning to the first position. Additionally, the first flap 302a can include a hooked portion 304. The hooked portion 304 can prevent items (e.g., cans) below the first flap 302a from directly pushing up on the first flap 302a, thereby protecting the first flap 302a and preventing cans from being pushed out of a top of the can rack system.

The back bumper 300 can also include a second flap 302b. A raised step 310 can be between the first flap 302a and the second flap 302b to enable the first flap 302a to move independently of the second flap 302b. Additionally, a flange 306 can protrude from the second flap 302b for removably coupling the back bumper 300 with the can rack system. For example, the flange 306 can be inserted into a slot in a back wall of the can rack system. The flange 306 and the second flap 302b can further be hooked on to the back wall. As a result, the second flap 302b can be in contact with an inner side of the back wall and the flange 306 can be in contact with an outer side of the back wall. Friction between the flange 306 and the back wall, friction between the second flap 302b and the back wall, or a combination thereof can maintain the coupling of the back bumper 300 to the can rack system.

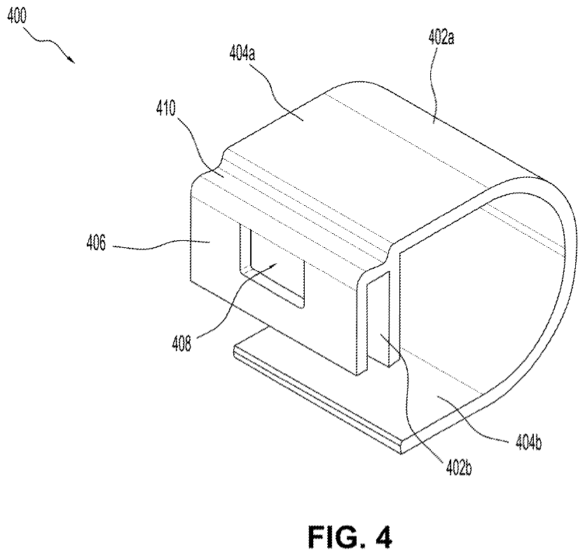

FIG. 4 depicts another example of a back bumper 400 for a can rack system according to some embodiments of the present disclosure. The back bumper 400 can include a first flap 402a, which can be a large, rounded flap. The first flap 402a may extend a distance into a compartment of the can rack system that is greater than half of a width of the compartment. The first flap 402a can repeatedly flex to slow cans as cans are inserted into the can rack system. For example, a falling can may contact an upper side 404a of the first flap 402a, thereby causing the first flap 402a to flex downward. After the falling can is below the first flap 402a, the first flap 402a can return to a first position, as depicted. The large, rounded shape of the first flap 402a can be more structurally sound and can exhibit a higher impact resistance in comparison with a flat flap. Thus, the back bumper 400 may be employed in the can rack system for slowing heavy cans. Additionally, a bottom side 404b of the first flap 402a can prevent items (e.g., cans) from being pushed out of a top of the can rack system.

The back bumper 400 can also include a second flap 402b. A raised step 410 can be between the first flap 402a and the second flap 402b to enable the first flap 402a to move independently of the second flap 202b. Additionally, a flange 406 can protrude from the second flap 402b to allow the back bumper 400 to be removably coupled to the can rack system. The flange 406 can include a flange hole 208, which can be used to further secure the connection between the can rack system and the back bumper 400.

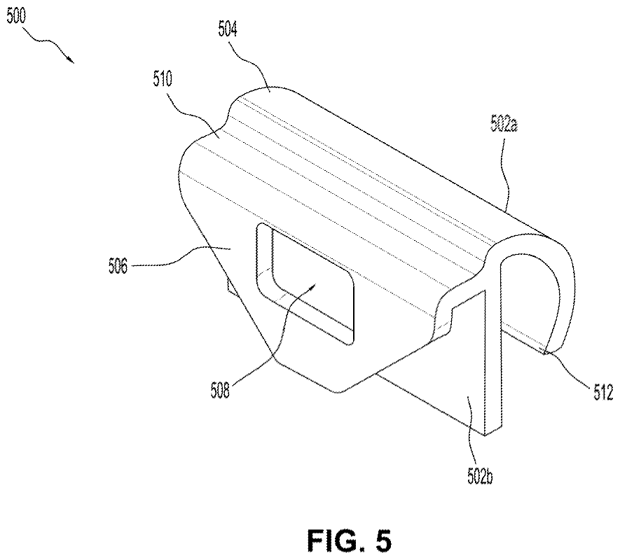

FIG. 5 depicts another example of a back bumper 500 for a can rack system according to some embodiments of the present disclosure. The back bumper 500 can include a first flap 502a, which can be a small, rounded flap. The first flap 502a may extend a distance into a compartment of the can rack system that is less than half of a width of the compartment. The first flap 502a can repeatedly flex to slow cans as cans are inserted into the can rack system. For example, a falling can may contact an upper side 504 of the first flap 502a, thereby causing the first flap 502a to flex downward. After the falling can is below the first flap 502a, the first flap 502a can return to a first position, as depicted. The small, rounded shape of the first flap 502a may exhibit a lower impact resistance in comparison with a long, flat or a large, rounded flap. Thus, the back bumper 500 may employed in the can rack system for slowing lighter cans that may not be heavy enough to cause the long flat or large rounded flap to flex.

Additionally, a bottom edge 512 of the first flap 502a can prevent items (e.g., cans) below the first flap 502a from directly pushing up on the first flap 502a. Thus, the bottom edge 512 can protect the first flap 502a and can prevent cans from being pushed out of a top of the can rack system.

The back bumper 500 can also include a second flap 502b. A raised step 510 can be between the first flap 502a and the second flap 502b to enable the first flap 502a to move independently of the second flap 502b. Additionally, a flange 506 can protrude from the second flap 502b for removably coupling the back bumper 500 with the can rack system. The flange 506 can include a flange hole 508, which can be coupled to a protruding portion of the can rack system to further secure the connection between the can rack system and the back bumper 500.

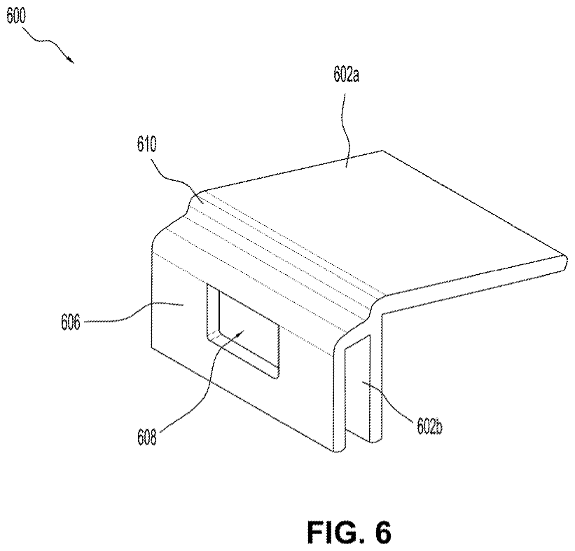

FIG. 6 depicts another example of a back bumper 600 for a can rack system according to some embodiments of the present disclosure. The back bumper 600 can include a first flap 602a, which can be a long, flat flap. The first flap 602a can repeatedly flex, from a first position, downward as cans falling through the can rack system each encounter the back bumper 600. In this way, the first flap 602a can repeatedly slow cans by providing some resistance to force exerted on the first flap 602a by each of the falling cans. Once each of the cans are below the first flap 602a, the first flap 602a can return to the first position.

The back bumper 600 can also include a second flap 602b. A raised step 610 can be between the first flap 602a and the second flap 602b to enable the first flap 602a to move independently of the second flap 602b. Additionally, a flange 606 can protrude from the second flap 602b. The flange 606 and the second flap 602b can be used to removably couple the back bumper 200 with the can rack system. A flange hole 608 in the flange 606 can couple to a protruding portion of the can rack system to secure a connection between the can rack system and the back bumper 200.

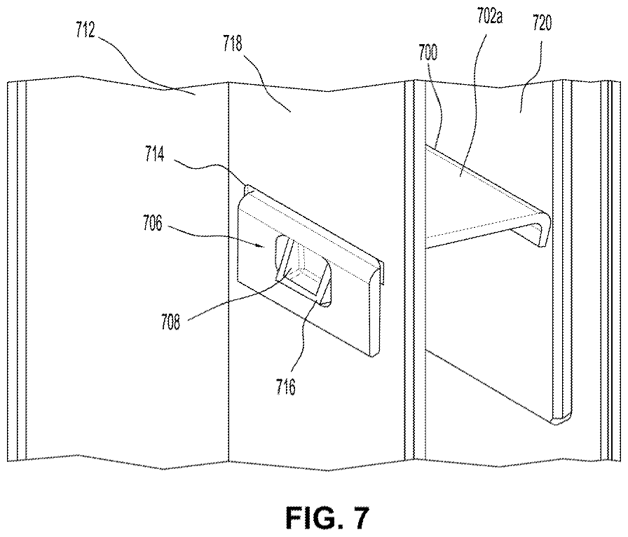

FIG. 7 depicts an example of a back bumper 700 coupled with a can rack system 712 according to some embodiments of the present disclosure. The back bumper 700 can correspond to the back bumper 200 depicted in FIG. 2. The can rack system 712 can correspond to the front loading can rack system 800 depicted in FIG. 8. The back bumper 700 can be removably coupled to the can rack system 712. For example, the back bumper 700 can include a flange 706, which can be inserted through a slot 714 in a back wall 718 of the can rack system 712. The flange 706 and a second flap (not shown) may further be hooked on to the back wall 718. In this way, the flange 706 can be positioned in contact with an outer side of the back wall 718 and the second flap can be position in contact with an inner side of the back wall 718.

Additionally, as a result of inserting the flange 706 through the slot and hooking the flange 706 and the second flap on to the back wall 718, a first flap 702a can be positioned within a compartment 720 of the can rack system 712. In this way, the first flap 702a can be in position to slow cans inserted into the can rack system 712 and falling through the compartment 720. Moreover, the back wall 718 can include a protruding portion 716. The protruding portion 716 can be coupled with the flange 706 via a flange hole 708 to further secure the attachment of the back bumper 700 to the can rack system 712.

The back bumper 700 can also be easily detached from the can rack system 712. For example, detaching the back bumper 700 from the can rack system 712 can include detaching the protruding portion 716 from flange 706, unhooking the flange 706 and the second flap from the back wall 718, and sliding the flange 706 out of the slot 714.

FIG. 8 depicts a front view of a front loading can rack system 800 with a set of back bumpers 808a-f according to some embodiments of the present disclosure. The front loading can rack system 800 can be positioned in a refrigeration appliance, such as the refrigeration appliance 100 depicted in FIG. 1. For example, the front loading can rack system 800 can be positioned at least partially behind an ice maker on a door of the refrigeration appliance 100. The front loading can rack system 800 can include a top cover 802, which can prevent users from dropping cans into the rack from above, thereby preventing users from inserting cans incorrectly. The top cover 802 can be coupled with at least two walls of the front loading can rack system 800 to provide structural support to the walls. Additionally, in some examples, the top cover 802 may be used as a shelf within the refrigeration appliance.

The front loading can rack system 800 can further include front openings 804a-d. A first front opening 804a and a second front opening 804b can be positioned at a top of the front loading can rack system 800 directly below the top cover 802. The front openings 804a-b can be used to insert cans into the front loading can rack system 800. For example, a user may insert a can via the first front opening 804a into a first compartment 801a of the front loading can rack system 800. Additionally, a third front opening 804c and a fourth front opening 804d can be positioned on a bottom of the front loading can rack system 800. The front openings 804c-d can be used to retrieve cans from the front loading can rack system 800. For example, the can inserted into the first compartment 801a can fall to the bottom of the front loading can rack system 800. The can may be stored at the bottom for a period of time. Then, the user may retrieve the can via the third front opening 804c.

Additionally, front flaps 806a-d can be positioned on a front side of the front loading can rack system 800 to maintain cans within compartments 801a-b. For example, the front flaps 806a-d may prevent cans from falling out of a front side of the front loading can rack system 800. A first front flap 806a and a second front flap 806b can be associated with the first compartment 801a. A third front flap 806c and a fourth front flap 806d can be associated with a second compartment 801b. In an example, the compartments 801a-b may each hold up to six cans. Alternatively, the compartments 801a-b may hold a different number of cans (e.g., four, eight, or twelve cans). In some examples, a center wall can separate the compartments 801a-b. In other examples, the front loading can rack system 800 may consist of a different number of compartments, or the compartments may not be separated by a wall. Additionally, there can be a first gap 810a between the first front flap 806a and the second front flap 806b. There can also be a second gap 810b between the third front flap 806c and the fourth front flap 806d. The gaps 810a-b can provide a space through which the user may adjust cans positioned in the front loading can rack system 800. For example, the user may turn a can that is not positioned horizontally within the front loading can rack system 800.

Similarly, bottom flaps 812a-d can further maintain cans within the compartments 801a-b by preventing cans from falling out of a bottom side of the front loading can rack system 800. As depicted, a first bottom flap 812a and a second bottom flap 812b can be associated with the first compartment 801a, and a third bottom flap 812c and a fourth bottom flap 812d can be associated with the second compartment 801b. There can be a third gap 810c between the first bottom flap 812a and the second bottom flap 812b. There can also be a fourth gap 810d between the third bottom flap 812c and the fourth bottom flap 812d. The gaps 810c-d can provide a space through which the user may interact with cans. For example, a user may use the third gap 810c to lift a can out of third front opening 804c.

The front loading can rack system 800 can also include slots on a back wall 818 through which back bumpers 808a-f can be inserted. The back bumpers 808a-f can be removable from the front loading can rack system 800. The back bumpers can slow cans inserted into the compartments 801a-b as the cans fall to the bottom of the front loading can rack system 800 or on to another can. For example, the back bumpers can each have a flexible flap that can be in a first position. The first position can be parallel to the bottom flaps 212a-d of the front loading can rack system 800. In other examples, the first position can be angled upward or downward with respect to an angle of the bottom flaps 212a-d to provide varying levels of resistance to cans. For example, the flexible flaps being angled upward may provide more resistance than the flexible flaps being angled downward. The flexible flaps may flex downward due to a weight of a can contacting the back bumpers as the can falls through one of the compartments 801a-b. Then, the flexible flaps can flex upward to return to the first position. In this way, the back bumpers 808a-f can repeatedly slow cans to minimize damage to the cans, the front loading can rack system 800, or a combination thereof associated with an impact of cans inserted into the compartments 801a-b.

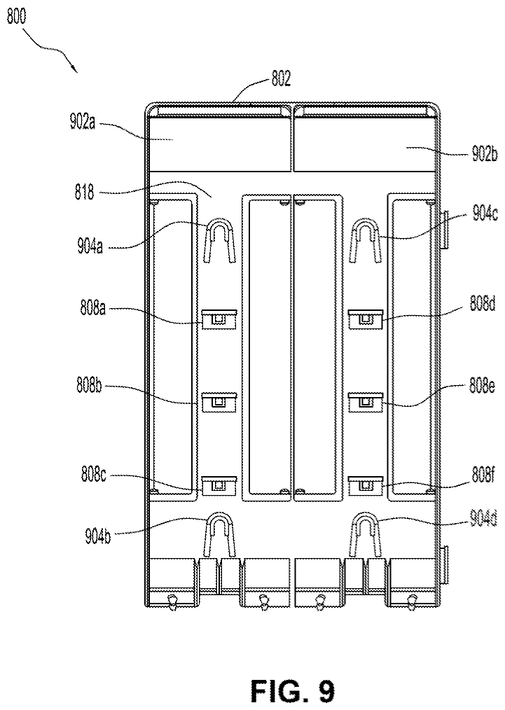

FIG. 9 depicts a back view of the front loading can rack system 800 with the set of back bumpers 808a-f according to some embodiments of the present disclosure. The front loading can rack system 800 can be positioned in a refrigeration appliance, such as the refrigeration appliance 100 depicted in FIG. 1. To position the front loading can rack system 800 within the refrigeration appliance 100, the front loading can rack system 800 can include back cutouts 902a-b. For example, the front loading can rack system 800 can be positioned at least partially behind an ice maker on a door of the refrigeration appliance 100. Thus, the back cutouts 902a-b can be sized and positioned to fit around the ice maker. In other examples, the front loading can rack system 800 can be below the ice maker or otherwise positioned on the door of the refrigeration appliance. Thus, the back cutouts 902a-b can also be sized and positioned fit around other features of the refrigeration appliance such as shelves. In this way, the front loading can rack system 800 can be seamlessly integrated within the refrigeration appliance to maximize usable volume within the refrigeration appliance.

Additionally, the front loading can rack system 800 can include hook mechanisms 904a-d. The hook mechanisms 904a-d can be positioned on one or more back walls 818. The hook mechanisms 904a-d can hook onto bolts of the refrigeration appliance to hold the front loading can rack system 800 in place. For example, the ice maker can include bolts around which the hook mechanisms 904a-b can be fastened. For example, the hook mechanisms 904a-d can each include a lower portion that is wider than an upper portion to facilitate easy installation of the front loading can rack system 800. Then, the upper portion can be sized to fit securely around the bolts. Thus, fastening the hook mechanisms 904a-d around the bolts can include aligning the lower portion of each of the hook mechanisms 904a-d with a bolt. Then, the can rack system 800 may be moved downward to cause the upper portion of each of the hook mechanisms 904a-d to fasten around at least a portion of each of the bolts.

Additionally, the back bumpers 808a-f can have flexible flaps positioned within compartments of the front loading can rack system 800. The back bumpers 808a-f can also each have a flange, which can be inserted through slots in the back wall 818. The back bumpers 808a-f can further hook onto the front loading can rack system 800. To do so, a second flap and a flange of each of the back bumpers 808a-f can be positioned on opposing sides of the back wall 818. Additionally, a flange hole of the flange can be coupled to a protruding portion of the back wall 818.

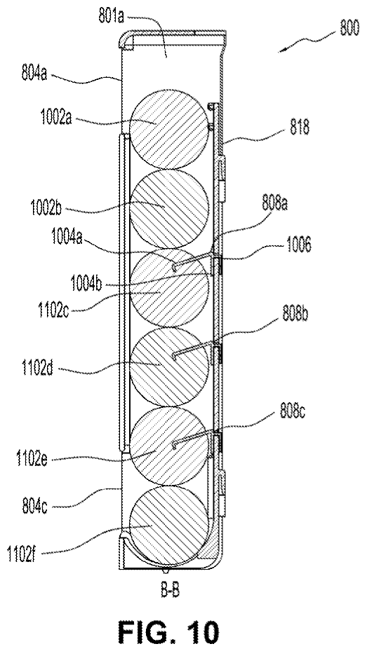

FIG. 10 depicts a cross sectional view of the front loading can rack system 800 with a set of back bumpers 808a-c according to some embodiments of the present disclosure. Cans 1002a-f can be stored in a first compartment 801a of the front loading can rack system 800. The cans 1002a-f may have been inserted via a first front opening 804a and can be dispensed via a third front opening 804c. As depicted, each of the back bumpers 808a-f can include a first flap 1004a positioned within the first compartment 801a. The first flap 1004a can be flexed downward in a second position due to a weight of the cans 1002a-f stored in the first compartment 801a. The back bumpers 808a-c can also include a second flap 1004b and a flange 1006, which can be hooked on to a back wall 818 of the front loading can rack system 800.

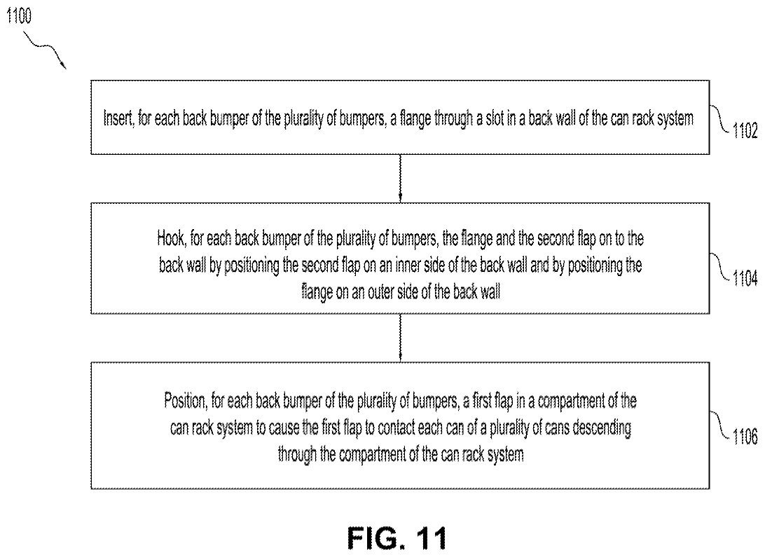

FIG. 11 is a flowchart of process 1100 for installing a back bumper in a front loading can rack system according to one example of the present disclosure. While FIG. 11 depicts a certain sequence of steps for illustrative purposes, other examples can involve more steps, fewer steps, different steps, or a different order of the steps depicted in FIG. 11. The steps of FIG. 11 are described below with reference to the components of FIGS. 1-10 described above.

At block 1102, the process 1100 involves installing a plurality of back bumpers 808a-f in a can rack system by inserting, for each back bumper of the plurality of bumpers 808a-f, a flange 206 through a slot in a back wall of the can rack system. The can rack system can correspond to the front loading can rack system 800 depicted in FIG. 8. The flange 206 can protrude from a second flap 202b of each of the back bumpers 808a-f.

At block 1104, the process 1100 involves installing the plurality of back bumpers 808a-f in the can rack system by hooking, for each back bumper of the plurality of bumpers, the flange 206 and the second flap 202b on to the back wall by positioning the second flap 202b on an inner side of the back wall and by positioning the flange 206 on an outer side of the back wall. In this way, the back bumpers 808a-f can be securely and removably attached to the can rack system. Additionally, in some examples, the back wall can include a protruding portion. The protruding portion can be coupled to the flange 206 via a flange hole 208 to further secure the attachment of the back bumpers 808a-f to the can rack system.

At block 1106, the process 1100 involves installing the plurality of back bumpers 808a-f in the can rack system by positioning, for each back bumper of the plurality of bumpers 808a-f, a first flap 202a in a compartment of the can rack system to cause the first flap 202a to contact each can of a plurality of cans descending through the compartment of the can rack system. The first flap 202a can flex, from a first positioned, downward to a second position in response to pressure exerted by the cans descending through the compartment while the cans are in contact with the first flap 202a. The first flap 202a may then flex upward from the second position to first position when the cans descending through the compartment are below, and no longer in contact with, the first flap 202a.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A back bumper for a can rack system, the back bumper comprising:
a first flap, the first flap configured to flex, from a first position, downward to a second position in response to pressure exerted by a can descending through a compartment of the can rack system while the can is in contact with the first flap, and the first flap configured to flex upward from the second position to the first position when the can descending through the compartment is below and no longer in contact with the first flap;
a second flap positioned substantially perpendicular to the first position of the first flap;
a raised step positioned between the second flap and the first flap, the raised step configured to enable the first flap to move independently of the second flap; and
a flange protruding from the second flap, the flange and the second flap configured to removably couple the back bumper to the can rack system by hooking on to a back wall of the can rack system such that the second flap is positioned on an inner side of the back wall and the flange is positioned on an outer side of the back wall.

2. The back bumper of claim 1, wherein the first flap is a flat flap, wherein the flat flap extends into the compartment of the can rack system.

3. The back bumper of claim 2, wherein the flat flap further comprises a hooked portion, wherein the raised step extends from a first edge of the flat flap, and wherein the hooked portion extends from a second edge of the flat flap.

4. The back bumper of claim 1, wherein the flange further comprises a flange hole, wherein the back wall of the can rack system further comprises a protruding portion, and wherein hooking the flange and the second flap on to the back wall of the can rack system further comprises coupling the protruding portion to the flange via the flange hole.

5. The back bumper of claim 1, wherein the can rack system comprises at least one slot, and wherein hooking the flange and the second flap on to the back wall further comprises inserting the flange through a slot of the at least one slot.

6. The back bumper of claim 1, wherein the first flap is a large rounded flap, wherein the large rounded flap extends into the compartment a distance that is greater than half of a width of the compartment, and wherein the large rounded flap is configured to flex, from the first position, downward to the second position in response to pressure exerted by the can on an upper side of the large rounded flap.

7. The back bumper of claim 1, wherein the first flap is a small rounded flap, wherein the small rounded flap extends into the compartment a distance that is less than half of a width of the compartment, and wherein the small rounded flap is configured to flex, from the first position, downward to the second position in response to pressure exerted by the can on an upper side of the small rounded flap.

8. A can rack system comprising:
a plurality of back bumpers, each back bumper of the plurality of back bumpers comprising:
a first flap, the first flap configured to flex, from a first position, downward to a second position in response to pressure exerted by a can descending through a compartment of the can rack system while the can is in contact with the first flap, and the first flap configured to flex upward from the second position to first position when the can descending through the compartment is below and no longer in contact with the first flap;
a second flap positioned substantially perpendicular to the first position of the first flap;
a raised step positioned between the second flap and the first flap, the raised step configured to enable the first flap to move independently of the second flap; and
a flange protruding from the second flap, the flange and the second flap configured to removably couple the back bumper to the can rack system by hooking on to a back wall of the can rack system such that the second flap is positioned on an inner side of the back wall and the flange is positioned on an outer side of the back wall.

9. The can rack system of claim 8, wherein the first flap of each back bumper of the plurality of back bumpers is a flat flap, and wherein the flat flap extends into the compartment of the can rack system.

10. The can rack system of claim 9, wherein the flat flap of each back bumper of the plurality of back bumpers further comprises a hooked portion, wherein the raised step extends from a first edge of the flat flap, and wherein the hooked portion extends from a second edge of the flat flap.

11. The can rack system of claim 8, wherein the flange of each back bumper of the plurality of back bumpers further comprises a flange hole, wherein the back wall of the can rack system further comprises a protruding portion, and wherein hooking the flange and the second flap on to the back wall further comprises coupling the protruding portion to the flange via the flange hole.

12. The can rack system of claim 8, further comprising a plurality of slots, wherein hooking the flange and the second flap on to the back wall comprising inserting the flange of each back bumper of the plurality of back bumpers through a slot of the plurality of slots.

13. The can rack system of claim 9, wherein the first flap of each back bumper of the plurality of back bumpers is a large rounded flap, wherein the large rounded flap extends into the compartment a distance that is greater than half of a width of the compartment, and wherein the large rounded flap is configured to flex, from the first position, downward to the second position in response to pressure exerted by the can on an upper side of the large rounded flap.

14. The can rack system of claim 9, wherein the first flap is a small rounded flap, wherein the small rounded flap extends into the compartment a distance that is less than half of a width of the compartment, and wherein the small rounded flap is configured to flex, from the first position, downward to the second position in response to pressure exerted by the can on an upper side of the small rounded flap.

15. A method comprising:
installing a plurality of back bumpers in a can rack system by:
inserting, for each back bumper of the plurality of bumpers, a flange through a slot in a back wall of the can rack system, the flange protruding from a second flap:
hooking, for each back bumper of the plurality of bumpers, the flange and the second flap onto the back wall by positioning the second flap on an inner side of the back wall and by positioning the flange on an outer side of the back wall; and
positioning, for each back bumper of the plurality of bumpers, a first flap in a compartment of the can rack system to cause the first flap to contact each can of a plurality of cans descending through the compartment of the can rack system, the first flap configured to flex, from a first position, downward to a second position in response to pressure exerted by the can descending through the compartment while the can is in contact with the first flap, and the first flap configured to flex upward from the second position to first position when the can descending through the compartment is below and no longer in contact with the first flap.

16. The method of claim 15, wherein the first flap is a flat flap.

17. The method of claim 16, wherein each back bumper of the plurality of back bumpers further comprises a raised step positioned between the second flap and the second flap and configured to enable the first flap to move independently of the second flap, wherein the flat flap further comprises a hooked portion, wherein the raised step extends from a first edge of the flat flap, and wherein the hooked portion extends from a second edge of the flat flap.

18. The method of claim 15, wherein the flange further comprises a flange hole, wherein the back wall of the can rack system further comprises a protruding portion, and wherein hooking the flange and the second flap on to the back wall of the can rack system further comprises coupling the protruding portion to the flange via the flange hole.

19. The method of claim 15, wherein the first flap is a large rounded flap, wherein the large rounded flap extends into the first compartment a distance that is greater than half of a width of the compartment, and wherein the large rounded flap is configured to flex, from the first position, downward to the second position in response to pressure exerted by the can on an upper side of the large rounded flap.

20. The method of claim 15, wherein the first flap is a small rounded flap, wherein the small rounded flap extends into the first compartment a distance that is less than half of a width of the compartment, and wherein the small rounded flap is configured to flex, from the first position, downward to the second position in response to pressure exerted by the can on an upper side of the small rounded flap.
